(19) United States
(12) Patent Application Publication
(10) Pub. No.: US 2026/0050772 A1
(43) Pub. Date: Feb. 19, 2026

(54) GENERATIVE AI TECHNIQUES GUIDED BY NETWORK SIGNALS

(71) Applicant: Google LLC, Mountain View, CA (US)

(72) Inventors: Victor Carbune, Zurich (CH); Marius Ioan Dragus, Zurich (CH); Andrei-Bogdan Pârvu, Zürich (CH); Vlad Voicu, Basel (CH)

(21) Appl. No.: 18/807,637

(22) Filed: Aug. 16, 2024

(51) Int. Cl. G06N 3/0475

(52) U.S. Cl. CPC G06N 3/0475

(57) ABSTRACT

Methods, systems, and apparatus, including computer programs encoded on a computer storage medium, for generating digital content using artificial intelligence. In one aspect, a method includes receiving, by an AI system, a request including text input descriptive of features of a digital component and one or more properties of a digital network associated with displaying the digital component. The AI system generates one or more prompts for use by one or more models to generate one or more digital components. The one or more prompts are generated based on the text input and the one or more properties of the digital network. The AI system obtains, from the one or more models, a digital component generated by the one or more models based on at least one of the one or more prompts. The digital components are distributed to the digital network for rendering at one or more client devices.

### BACKGROUND

This specification relates to data processing, artificial intelligence, and generating digital content.

Recent developments in artificial intelligence and, in particular, generative artificial intelligence have caused user-produced content such as digital images, videos, and text content to become ubiquitous. For example, various types of digital content can be generated by using text-to-image models based on text prompts. However, current generative artificial intelligence models often produce content that is tied to the content generation itself without considering aspects of the content deployment and utility of content when exposed at an environment of the end user.

### SUMMARY

In general, a first innovative aspect of the subject matter described in this specification can be embodied in methods that include the actions of receiving, by an artificial intelligence system, a request including text input descriptive of features of a digital component and one or more properties of a digital network associated with displaying the digital component; generating, by the artificial intelligence system, one or more prompts for use by one or more models to generate one or more digital components, wherein the one or more prompts are generated based on the text input and the one or more properties of the digital network; obtaining, by the artificial intelligence system and from the one or more models, a digital component generated by the one or more models based on at least one of the one or more prompts; and distributing the digital component to the digital network for rendering at one or more client devices. Other implementations of this aspect include corresponding apparatus, systems, and computer programs, configured to perform the aspects of the methods encoded on computer storage devices.

These and other embodiments can each optionally include one or more of the following features. In some implementations, a prompt of the one or more prompts is generated, using a language model aligned with a performance criterion for digital components to be distributed to the digital network, to improve performance of the digital component based on the one or more properties of the digital network.

In some aspects, the one or more models are trained to generate a prompt of the one or more prompts, the prompt being fitted to improve performance of a generated digital component for a given first performance aspect selected for the digital network as indicative of relevance of the digital component to target users of the digital network.

In some aspects, obtaining the digital component includes generating a plurality of digital components by the one or more models, each digital component being generated based on a different prompt of the one or more prompts; predicting, using a reward model trained on performance data collected for the digital network, performance metrics for performance aspects of each of the plurality of digital components, wherein the performance metrics are predicted using a trained reward model; and selecting the digital component from the plurality of digital components based on the performance metrics so that the digital component of the plurality of digital components has a performance metric meeting a selection criterion.

Some aspects include training the reward model, the training comprising: obtaining training data from the digital network, wherein the training data comprises: i) metadata for features of digital components displayed through the digital network, ii) properties of the digital component associated with a type of the digital network and the digital components, and iii) log data for user interaction with digital components displayed through the digital network at client devices; and using the training data to train the reward model to learn to estimate performances of digital components according to the given performance aspect.

Some aspects include using the training data to train the reward model to predict prompts fitted to improve performance with respect to a given performance aspect defined for the digital network, the predicted prompts being generated based on obtained requests, wherein the predicted prompts are for generating digital components having estimated performances meeting performance criteria defined for the given performance aspect.

In some aspects, obtaining the digital component comprises: dynamically obtaining a signal from a performance evaluation model, the signal including input information for performance of digital components when deployed at the digital network; evaluating a prompt of the at least one prompt based on the obtained signal to verify if the prompt is optimized to provide a digital component with improved performance metric for the selected performance aspect; in response to determining that the prompt is not optimized to improve the performance aspect, generating a new prompt using the reward model; sending a request, by the artificial intelligence system and to the one or more models, to generate a refined digital component by guiding modifications for the digital component based on the new prompt; and obtaining, from the trained model, the refined digital component based on executing the request at the one or more models.

In some aspects, obtaining the digital component comprises: dynamically obtaining a signal from a performance evaluation model, the signal including input information for performance of digital components when deployed at the digital network; evaluating the digital component by evaluating the obtained signal based on defined performance metric for a selected performance aspect; in response to determining that the digital component is not optimized to improve the selected performance aspect, sending a request, by the artificial intelligence system and to the one or more models, to generate a refined digital component by guiding modifications for the digital component based on performance of the digital component for the selected performance aspect; and obtaining, from the trained model, the refined digital component based on executing the request at the one or more models.

In some aspects, the one or more properties comprise at least one of a type of the digital network, a type of device that rendered digital components from the digital network, or a target user profile for the digital network.

Similar operations and processes may be performed in a system comprising at least one process and a memory communicatively coupled to the at least one processor where the memory stores instructions, that when executed, cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description, drawings, and claims.

Particular embodiments of the subject matter described in this specification can be implemented so as to realize one or more of the following advantages. The techniques described in this specification enable artificial intelligence (AI) to be used to generate customized content, e.g., customized digital components, based on data related to the digital components and data related to properties of a digital network where the digital components are to be deployed and interacted with by users. The process of digital component creation can be improved by using trained models to guide the generation to optimize or at least improve their performance when provided to and/or for interaction with users.

The techniques described in this document support efficient utilization of computer resources based on the ability to learn from input obtained from a digital network, train models to estimate the performance of digital components based on properties of the digital network, digital components, and/or target users, and create refined prompts and/or digital components based on the trained model(s). For example, such processes can reduce network calls between an AI system and a generation component for generating user-defined digital components, since the process can be guided based on learned patterns from previous generations (e.g., based on monitoring previous end-user interactions) with the generated content at the digital network. In some instances, the learned patterns can be used and applied for the generation of digital components in a more efficient setup. In such instances, digital components that match a defined criterion for performance for the digital network can be provided faster compared to cases requiring re-generation to adjust the content of the digital component once the digital component has been generated and provided to the digital network and does not match with the performance criterion.

Further, the AI system can generate content that takes into account an understanding of how a digital component performs within each context (e.g., within each digital network) in which the digital component may be presented, thereby ensuring the version of the digital component presented in each context is the best performing version of the digital component in that context. Using performance predictions based on digital network features in generating new content improves the quality (e.g., relevance and/or aesthetics) of the content without relying on direct input from a production context of the digital network. In some instances, the performance prediction can be based on historical data including data related to utilization of digital components when provided in the production context of the digital network. In some examples, the historical data can include obtained feedback from users who consumed content from digital components provided through the digital network. Such historical data can be used to train a language model or other type of AI model to generate digital components that are associated with better performance(s) (e.g., according to a performance scale related to one or more performance criteria) compared to performance(s) that can be expected if such data were not leveraged in the digital component generation process. For example, based on using historical data related to performance associated with one or more performance criteria, a type of content to include in future digital component can be determined. The determined type of content can be relevant for the generation of digital components that are associated with higher performance measurement(s) for the respective performance criterion compared to those that can be expected if historical data were not used. For example, it can be determined to include images (e.g., logos) when generating digital components to improve their performance with regard to a particular performance criteria. In another example, one type of logo for an item may result in better perform on one digital network (e.g., a video sharing platform) while another type of logo may result in better performance on another digital network (e.g., a web page).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which generative artificial intelligence can be implemented to generate digital components.

FIG. 2 is a block diagram illustrating interactions between an artificial intelligence system, AI models, and a client device.

FIG. 3 is a flow chart of an example of a process for generating and distributing digital components with improved performance within a digital network.

FIG. 4 is a flow chart of an example of a process for generating a digital component based on a prompt generated to improve performance of the digital component for one or more properties of the digital component and/or the digital environment in which the digital component will be presented.

FIG. 5 is a block diagram of an example architecture of a system for providing a digital component.

FIG. 6 is a flow diagram of an example of a process for generating a refined digital component based on a prompt optimized to improve performance of a generated digital component at a digital network.

FIG. 7 a block diagram of an example computer.

Like reference numbers and designations in the various drawings indicate like elements.

### DETAILED DESCRIPTION

This specification describes techniques for enabling artificial intelligence to generate new digital components in a faster and more efficient way by using prompts that are re-generated so as to be adapted to a target context of a digital network and/or by applying a selection among generated digital components (that are not yet deployed at the digital network) to determine a digital component that is adapted to, e.g., optimized to, a target context at a digital network. In accordance with implementations of the present disclosure, a digital component can be provided according to considerations of the performance of digital components at a given digital network, those specifics being related to the type of the digital network and type of entity where the content of the digital component is released, display properties associated with an end-user device that presents the digital component, and positioning of the digital component when rendered at a client device of a user, and/or the features of the digital components, among others. For example, the digital component generation process can be implemented to consider insight into the performance of digital components at a particular digital network where the digital components are to be deployed. In such a manner, the digital components can be generated for a particular context in the digital network. In some instances, the process can use input descriptive of the digital components and also input related to predicted performances of digital components at the particular context to guide the process of the digital component generation.

Artificial intelligence (AI) is a segment of computer science that focuses on the creation of models that can perform tasks and actions autonomously, e.g., with little to no human intervention. AI systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts.

The techniques described throughout this specification enable AI to generate digital components using various combinations of text, images, audio, and/or video to improve the performance of the digital components when deployed in a given digital network. The AI models can be trained or otherwise adapted to one or more digital networks. A digital network can refer to a type or electronic resource with which digital components are presented. Example digital networks include video sharing platforms and applications, web sites, search pages, audio streaming platforms and applications, and gaming platforms and applications, to name just a few.

In some implementations, an AI system can be enabled to generate digital components using various combinations of text, images, and/or other types of content (e.g., videos, audio, graphics) by generating and providing refined prompts as inputs to one or more AI models, e.g., one or more language models, diffusion models, and/or other types of AI models. In some implementations, the AI system can be enabled to evaluate generated digital components and identify those digital components that are associated with the highest performance scores (or scores meeting a selection criterion) at a target digital network. The AI system can obtain insight for the performance of digital components that can be used to refine prompts or to select best-fit digital components from multiple candidate components from trained models, according to training data obtained from a running digital network exposing digital components to end users.

Generally speaking, the AI system can generate a digital component based on initial data related to a subject of the digital component that is to be generated using an AI model and data related to properties of the environment (e.g., including an environment where the digital component is to be displayed such as a user device) that is to be used for exposing the digital component when deployed at a digital network. For example, the initial data can include the name of an entity (e.g., the name of a business) that is the subject of the digital component or that is related to the subject (e.g., the subject can be a product and the entity can be the business that offers the product), headlines or other text of these other digital components, text descriptions of the subject or entity, and/or other data related to the subject or entity. Further, the data related to properties of the environment can include a type of a device that is to be used for rendering the digital component, e.g., a television, a mobile phone, a tablet, other, a screen size of the device, a resolution of the screen, etc. The data related to the properties of the environment can include properties of the digital network, e.g., the type of the digital network (e.g., video sharing or gaming) and/or content of a particular resource within that network (e.g., keywords of web page, a video being presented to a user on a video sharing application, etc.). The data related to the properties of the environment can also include data related to how the digital component will be presented, e.g., the number of digital component slots of a resource, the location of each digital component slot within the resource, the types and/or sizes of the digital component slots, a time-based location for a digital component in a video or audio stream, etc. The provided data for the digital component generation can be used to refine a prompt to be used for the generation, can be used to evaluate candidate digital components already generated, or can be used to retrain a model to generate digital components optimized, or at least improved, for a given digital network based on performance data that indicates performance of digital components at the digital network.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

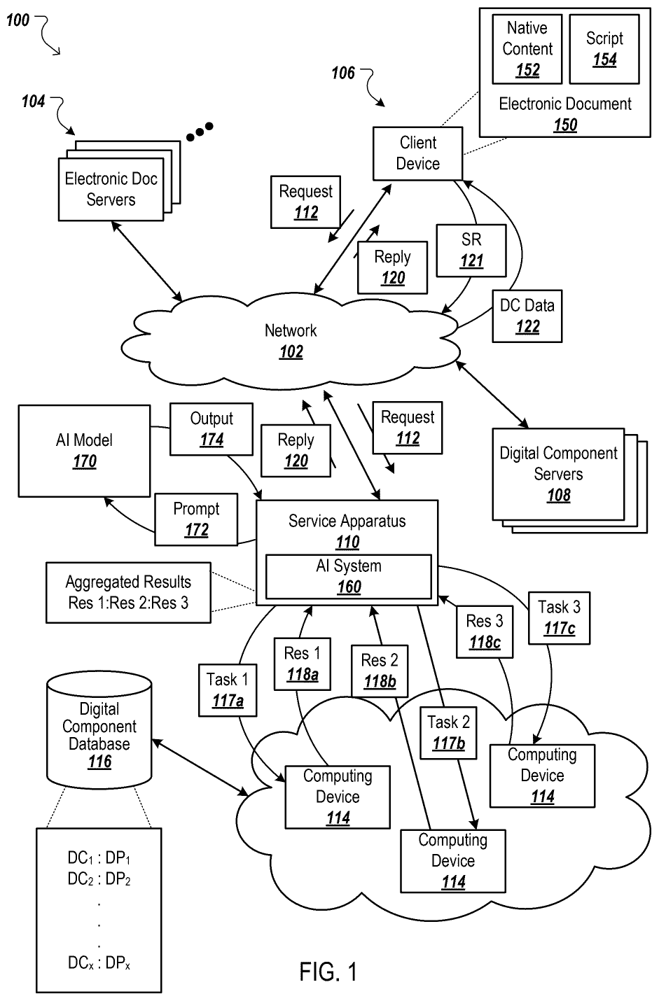

FIG. 1 is a block diagram of an example environment 100 in which generative AI can be implemented to generate digital components. The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or provided by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content on a client device 106. Examples of electronic documents include online resources, webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate the presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as the name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital components can be presented. For example, event data specifying a reference (e.g., URL) to an electronic document (e.g., webpage), in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data), and provide to the service apparatus 110 to facilitate identification of digital components that are eligible for presentation with the electronic document. The event data can also include a query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated, even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, such as, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking measure, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match the information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114, may identify a subset of digital components that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114, and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106 the digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is presented.

The service apparatus 110 can also include an artificial intelligence (“AI”) system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and summarize the collected online content using one or more AI models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as website content, search results, news articles, or research papers; answer questions about text, such as “What is the capital of Georgia?”; create chatbots that can have conversations with humans; and generate creative text, such as poems, stories, and code.

The AI model 170 can be any appropriate language model neural network that receives an input sequence made up of text tokens selected from a vocabulary and auto-regressively generates an output sequence made up of text tokens from the vocabulary. For example, the AI model 170 can be a Transformer-based language model neural network or a recurrent neural network-based language model.

In some situations, the AI model 170 can be referred to as an auto-regressive neural network when the neural network used to implement the AI model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precedes the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the AI model 170 can process the current input sequence to generate a score distribution, e.g., a probability distribution, that assigns a respective score, e.g., a respective probability, to each token in the vocabulary of tokens. The neural network of the AI model 170 can then select, as the particular token, a token from the vocabulary using the score distribution. For example, the neural network of the AI model 170 can greedily select the highest-scoring token, or can sample, e.g., using nucleus sampling or another sampling technique, a token from the distribution.

As a particular example, the AI model 170 can be an auto-regressive Transformer-based neural network that includes (i) a plurality of attention blocks that each apply a self-attention operation and (ii) an output subnetwork that processes an output of the last attention block to generate the score distribution.

The AI model 170 can have any of a variety of Transformer-based neural network architectures. Examples of such architectures include those described in J. Hoffmann, S. Borgeaud, A. Mensch, E. Buchatskaya, T. Cai, E. Rutherford, D.d. L. Casas, L.A. Hendricks, J. Welbl, A. Clark, et al. Training compute-optimal large language models, arXiv preprint arXiv:2203.15556, 2022; J.W. Rae, S. Borgeaud, T. Cai, K. Millican, J. Hoffmann, H.F. Song, J. Aslanides, S. Henderson, R. Ring, S. Young, E. Rutherford, T. Hennigan, J. Menick, A. Cassirer, R. Powell, G. van den Driessche, L.A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S.M. Jayakumar, E. Buchatskaya, D. Budden, E. Sutherland, K. Simonyan, M. Paganini, L. Sifre, L. Martens, X.L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B.A. Hechtman, L. Weidinger, I. Gabriel, W.S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence, and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same AI model 170 to generate multiple different candidate output sequences in response to the same request, e.g., by using beam search decoding from score distributions generated by the AI model 170, using a Sample-and-Rank decoding strategy, by using different random seeds for the pseudo-random number generator that is used in sampling for different runs through the AI model 170, or using another decoding strategy that leverages the auto-regressive nature of the language model.

In some implementations, the AI model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the AI model 170 (e.g., the neural network) on a language modeling task, e.g., a task that requires predicting, given a current sequence of text tokens, the next token that follows the current sequence in the training data. As a particular example, the AI model 170 can be pre-trained on a maximum-likelihood objective on a large dataset of text, e.g., text that is publicly available from the Internet or another text corpus.

In some implementations, the AI system 160 can generate a prompt 172 that is submitted to the AI model 170, and causes the language model 170 to generate the output sequences 174, also referred to simply as “output”. Furthermore, although a single AI model 170 is shown in FIG. 1, different models can be specially trained to process different prompts at different stages of the processing pipeline. For example, a more general (e.g., larger) language model can be used to generate the digital components based on provided prompts. Additionally, the AI system 160 can generate a set of candidate digital components (e.g., prior to receiving the request 112), where the set of candidate digital components can be stored in a database and/or can be provided for performance evaluation for deployment at a given digital network. In this scenario, when the AI system 160 receives the request 112, the AI system 160 can further evaluate the stored candidate digital components, e.g., for selection, based on additional information included in the request 112, and/or other contextual data (e.g., properties of a digital network relevant for the digital component, criteria for selection such as a particular one or more performance metrics evaluated for digital components at one or more digital networks.).

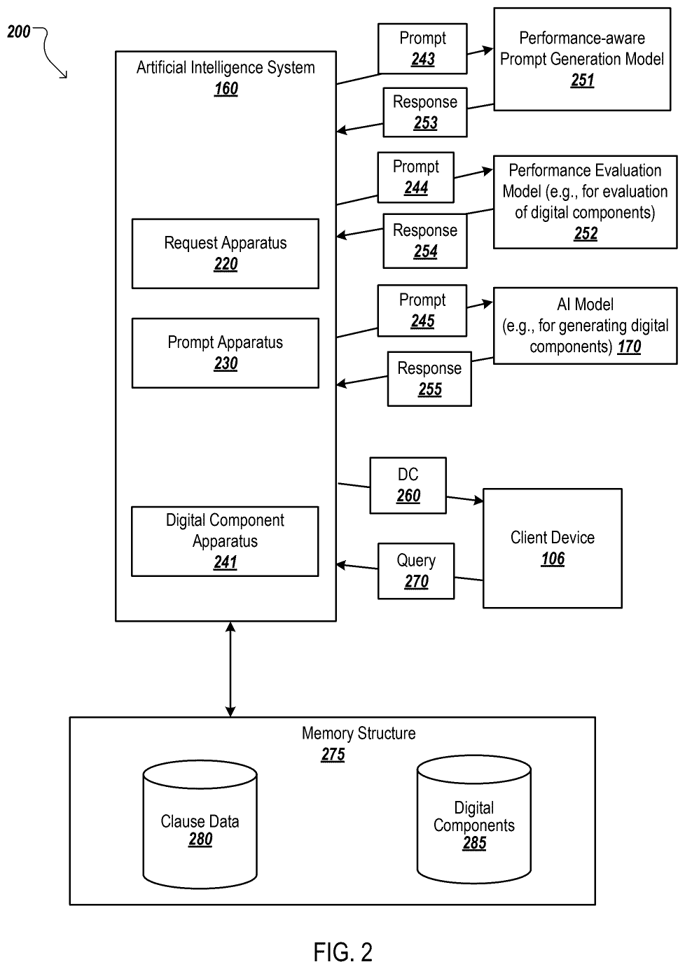

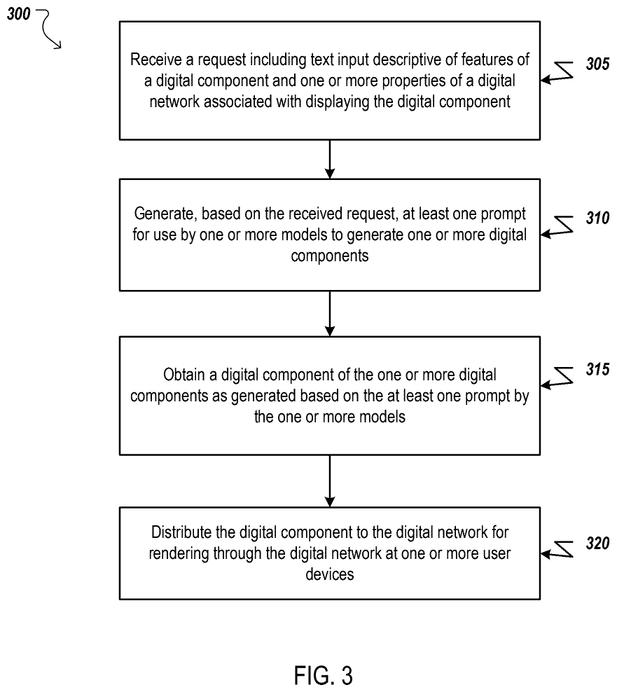

FIG. 2 is an illustration of a utilization of AI models that are trained to generate content that can include data generation, image generation, instructions generation, prompt generation, or another type of content as described throughout the present application. For example, content can be generated based on queries at models as described in relation to FIGS. 3, 4, 5, and 6.

The AI system 160 is configured to autonomously generate digital components, either prior to a request (e.g., offline) and/or in response to a request (e.g., real-time or on-the-fly) as described in relation to FIG. 1. For example, the request can be received from a client device 106 that can be the same as, or substantially similar to the client device 106 of FIG. 1. In accordance with the present disclosure, the AI system 160 can collect content, e.g., content that can be accessed on the Internet and/or from other networked or non-networked sources, about a specific entity (e.g., digital component provider or another entity such as an organization that publishes a digital component) and/or about a subject of the digital component to be provided.

The AI system 160 includes a digital component apparatus 241, a request apparatus 220, and a prompt apparatus 230. The digital component apparatus 241 can be configured to receive a request for generating a digital component and can use implemented logic to generate prompts to create digital components using trained AI models, such as the performance-aware prompt generation model 251, the performance evaluation model 252, and the AI model 170.

The request apparatus 220 is configured to obtain initial content related to a request received for providing a digital component. The request for the digital component can be included as part of the initial content input data descriptive of a digital component and data related to a digital network where the digital component is to be deployed. The digital component can be requested to be generated for a particular environment, e.g., a digital network, in which the digital component will be rendered at end-user devices (e.g., client devices 106). The generation of the digital component can be based on i) the descriptive input for the digital component or a digital component already generated based on the descriptive input and ii) input for properties of an environment where the digital component is to be deployed. For example, the request can be to generate a video for Brand X, product Y, to be rendered on a television and directed to users of a given user profile. In another example, the request can be to generate an image for Brand X, product Y, to be rendered in a gaming application running on a smartphone.

In some instances, the request can be also specific to an aspect of performance optimization for the given environment. For example, the request can specify one or more performance parameters for which the digital component should be optimized. The performance parameters can include, for example, metrics associated with users being able to memorize the digital component's content after viewing, the number of unique users to which the digital component is shown, interactions (e.g., clicks) with the digital component, conversion rate (e.g., a rate at which users that view the digital component perform a specified action), and view through rate,, among other examples. Such performance optimization can be based on obtaining data related to the actual performance of digital components within the digital network and learning to predict performance measurements for new digital components based on observed past patterns.

In some instances, the request apparatus 220 can obtain initial data for use in generating a digital component. In some instances, the initial data can include descriptive data of features of the digital component (e.g., product name, type of product, brand name, type of a digital component such as image or video, visual assets (e.g., images or videos), or other), visual related data, and properties of the digital network where the digital component is to be deployed (e.g., properties of devices to be used for rendering the digital component, positioning of the digital component on a rendered screen, other content as part of the context where the digital component is provided to client devices, etc.). For example, the properties of the digital network can include data indicating the type of the digital network, the resource (e.g., particular video, web page, or game) within the digital network with which the digital component will be presented, and properties of digital component slots of the resource.

In some instances, the request apparatus 220 can include logic to select at least a portion of the initial data and provide the selected data to be used for generating a prompt 243 that is provided to a performance-aware prompt generation model 251 or to the prompt apparatus 230 of the AI system 160. In some instances, the performance-aware prompt generation model 251 can be incorporated into the AI system 160, for example, as part of the prompt apparatus 230. The performance-aware prompt generation model 251, and/or the prompt apparatus 230 can generate prompts that can be directed to the AI model 170 for the generation of one or more digital components based on the provided prompt.

In some instances, the performance-aware prompt generation model 251 can be used to generate prompts conditioned on input data and also on improvement(s) of performance of a generated digital component for a respective performance aspect(s) (e.g., a performance parameter such as user interaction rate). For example, the performance aspect(s) can be selected for generation of digital components designated for the digital network, wherein the performance aspect(s) can be indicative of relevance or correspondence of the digital component to the context where the digital components are provided through the digital network. The context can include different aspects including the users, the device types, or the types of applications or other resources that render content of the digital components, among other examples.

In some instances, a reward model can be trained on training data including collected historical data indicative of performance of digital components provided through the digital network. In some instances, the historical data can include data indicative of user preferences based on monitored interactions of users with content of rendered digital components at devices connected to the digital network. In some instances, the reward model can be used through reinforcement learning techniques from human feedback (RLHF) to fine-tune a machine learning model to predict digital components as responses that are fit to a performance criterion for the digital network. In some other instances, the learned performance of digital components based on the user input (e.g., based on human preferences recorded in the historical data) can be used through direct performance optimization (DPO) techniques to improve the generation of digital components so that generated components are associated with performance measures according to a defined performance criterion for the digital network. In some instances, DPO techniques can ensure that a digital component generation component (e.g., the AI model 170) can learn to prioritize generating outcomes that are with performance measurement as per the defined criterion, e.g., above a certain threshold that can be associated with a level of preference to users that is acceptable, desirable, or otherwise defined for the digital components provided through the digital network. In some instances, the performance aspects can be defined based on observations of the actions of users after being exposed to the content of the digital component. For example, when a digital component is rendered through the digital network to a web application running on the mobile phones of users, the number of view times (e.g., above 10 seconds or other time periods) can be tracked as part of considerations for engagement of the users with the digital component as an example performance aspect. Another example is the number of clicks over content provided as part of the digital component (e.g., click on hyperlinks as part of the digital component, or images that reference web resources, among other examples). The number of clicks can also be measured and used for determining the engagement of users, as a standalone measure or in combination with views of the digital component and/or other interactions with the digital component (e.g., zoom out). In some instances, other performance aspects can be considered for digital components exposed at a digital network. For example, the conversion rate of an actual click over the digital component that results in the review of content at a web resource associated with the digital component. Such conversion rate can be tracked through tracking interaction with the web content of users and identifying click paths of users. In some other examples, the user engagement with the content can be considered as another performance aspect for the digital components. The user engagement metric can be determined by obtaining feedback from users with regard to the percentage of users who remember a digital component after seeing it rendered on their device, and other displayed content.

When the request apparatus 220 provides a request to the performance-aware prompt generation model 251, the request includes the selected data that is to be used to generate a refined prompt that is specific for the digital network where the digital component is to be deployed. The refined prompt that can be generated by the performance-aware prompt generation model 251 can be created by considering features of the digital component, for example, as defined in text input provided with the request that is descriptive of the features, and also by considering to generate a digital component that has optimal performance for the specifics of the digital network where the component is to be deployed. For example, the refined prompt can be generated to increase the likelihood of having performance metrics, according to a given performance aspect of the digital component, that meet a predefined criterion (e.g., above a threshold level). The performance of a digital component can be measured according to a scale defined for the performance aspect, where the scale can be a scale between 0 and 1, or can be defined with particular levels, such as “low”, “medium”, and “high”. Other example scales are also available. The performance of a given digital component can be considered in view of various aspects that can be related to the end-user interaction with the component and its effect on end-users in relation to an object of the digital component, e.g., a product or a brand. In some instances, performance of a digital component can be determined as an aggregate measure based on multiple performance aspects. In some cases, the performance can be determined as a weighted average where some performance aspects can be associated with a higher weight compared to other.

The refined prompt can be a performance-enhanced prompt that when used for generating a digital component, can yield a digital component with higher performance metrics determined for a given performance aspect compared to performance metrics that can be obtained for the digital component, if the component is generated based on prompts generated according to available techniques without considerations for optimization for the performance. The performance-aware prompt generation model can be a trained model based on obtained data from the digital network for previously provided digital components and user responses to such digital components.

In some instances, the request apparatus 220 can receive a request to generate a digital component. The request can include text related to the subject and/or entity relevant to the digital component, other digital components previously generated for the subject and/or entity, and/or other appropriate type of content, and/or data. Such input obtained by the request apparatus 220 can be combined together with a definition of the environment, where the digital component is to be deployed so that properties of the environment can be considered in the digital component generation process.

In some implementations, the request apparatus 220 receives a request for a digital component and can be configured to identify other resources available for the subject or entity of the digital component and extract them for use in the generation process. For example, previously generated digital components can be obtained, as well as other online resources related to the entity (e.g., product, brand, company, etc.). In some implementations, the request apparatus 220 is configured to identify online resources related to the subject and/or entity, extract data and/or images from the identified resources, and generate the initial data using the extracted data and/or images that can be provided to the prompt apparatus 230, or to the performance-aware prompt generation model 215.

The prompt apparatus 230 can generate the prompt 243 using a prompt template. The prompt template can include the request (or a portion thereof) and populatable fields for the initial data. For example, the prompt template can include a populatable field for a description of the entity and/or subject, the request, and populatable fields for other initial data.

The prompt apparatus 230 can provide a prompt to an AI model to request:
generation of a digital component, where the prompt can be directly used generating by an AI model to generate a digital component. For example, such prompt is prompt 245 sent to the AI model 170.
evaluation of generated components and select a component with estimated performance that meets a selection criterion. For example, such a prompt is prompt 244 that is sent to the performance evaluation model 252.
generation of a refined prompt that is designed for obtaining a digital component that has optimized performance at a given digital network. For example, such a prompt is prompt 243 that is sent to the performance-aware prompt generation model 251.

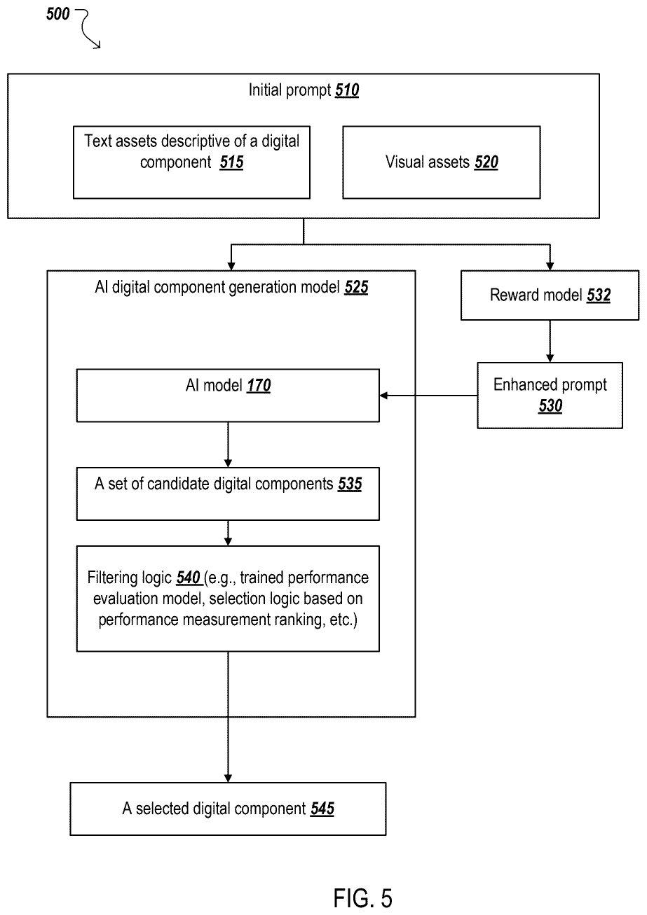

In some implementations, the performance evaluation model 252 can be used to evaluate generated digital components and identify a digital component that is optimal, or at least the best of those digital components, for a given performance aspect, e.g., is associated with the highest expected clicks on the digital component when deployed and exposed through a given digital network. In some instances, the performance evaluation model 252 can be used as part of implemented filtering logic to select a best-fit digital component, for example, as described in relation to the filtering logic 540 of FIG. 5.

The performance evaluation model 252 can be trained based on obtained training data from the digital network. The training can be performed based on training data including data for the digital components as deployed (e.g., digital component features and display characteristics), properties of the digital network (e.g., type of devices to render the digital components, type of content platform, etc.), and observed performance (e.g., user interaction data, engagement measurements with the content being shared, number of views, number of conversions etc.). The performance evaluation model 252 can be used to evaluate digital components and predict their performance measurements according to one or more performance aspects to determine a digital component (or more) that meet a performance criterion (e.g., are above a threshold performance level).

In some implementations, the digital components that can be evaluated by the performance evaluation model 252 can be digital components provided by the AI model 170. In some implementations, rather than using the performance evaluation model to identify a digital component that is already generated and is best suited for a given performance aspect, the AI model 170 can be retrained based on training data such as the training data used for training the performance evaluation model 252 or based on input from the performance evaluation model 252 during the digital component generation to guide the creation of the digital component to be best fit for a given performance aspect as constrained on the specifics (e.g., properties) of the digital network where the component is to be deployed. In some cases, the digital component generation at such a retrained AI model can be performed as an iterative process, where modifications of features of a generated digital component can be defined so that a subsequent version of a digital component can include at least one modified feature so that the predicted performance of the modified digital component would be higher compared to the predicted performance of the previous version of the digital component.

In some implementations, the digital component apparatus 241 can obtain generated digital components and can provide at least one digital component 260 to a client device 106 in response to the query 270. In some implementations, the generation of the digital components can be performed after or before receipt of a query 270. In the latter case, the AI system 160 can pre-store digital components that are generated for different digital networks and stored at a digital components storage 285 at the memory structure 275. In some implementations, generated clauses from the model 250 are obtained through the response 255, and can be stored by the AI system 160 at the memory structure 275, for example, at a clause data storage 280.

FIG. 3 is a flow chart of an example of a process 300 for generating and distributing digital components with improved performance within a digital network. Operations of the process 300 can be performed, for example, by the service apparatus 110 and/or the AI apparatus 160 of FIG. 1 or FIG. 2, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, the process 300 is described in terms of being performed by a system.

The process 300 can be performed as part of a request to generate digital components according to generative AI techniques. The request can include input that is descriptive of features of the digital component, as well as input related to characteristics of the digital network as an environment where the digital component is to be deployed. Any of the digital component data and context/environment data described above can be used in the process 300. The process 300 is tailored to generate digital components that provide the best-fit performance at a digital network according to an expected performance aspect (e.g., engagement with the content, interaction rate, viewing rate, etc.).

The system received a request including text input descriptive of features of a digital component and one or more properties of a digital network associated with displaying the digital component (305). In some instances, the one or more properties can include properties including at least one of a type of the digital network, a type of devices that display rendered digital components from the digital network, or a target user profile for the digital network.

For example, the request received at 305 can include an identification of the type of client devices to be used to display the digital components, e.g., a television, as well as a type of user profile, e.g., university students of age 22, as well as an identification of a brand associates, with the digital component as a feature. Based on such input from the request as well as other descriptive data of the digital component, a digital component can be generated to be optimized for performance at the digital network according to a given performance aspect, for example, to yield a rate of user interactions above a threshold value.

The system generates at least one prompt for use by one or more models to generate one or more digital components (310). The at least one prompt can be generated based on the text input and the one or more properties of the digital network.

In some instances, the prompt can be generated by a performance-aware prompt generation model, such as the model 251 of FIG. 2. The prompt can be adapted to be specific to improving performance metrics according to a one or more performance aspects in view of the provided one or more properties of the digital network. For example, the prompt can be adapted to request the generation of a digital component(s) that is directed to a mobile phone environment for viewing by users and is optimized to improve the expected performance of user clicks (as expected interactions with the digital component).

In some instances, the prompt can be generated as a prompt to request evaluation of generated digital components, for example, generated in accordance with the text input descriptive of features of the digital component as received at 305. In some instances, multiple digital components can be generated by one or more AI models (e.g., LLMs, diffusion models), and the prompt includes a request to evaluate the generated digital components (e.g., provided as part of the prompt or through a reference to a data storage where the components are accessible) according to a condition for optimization of their performance.

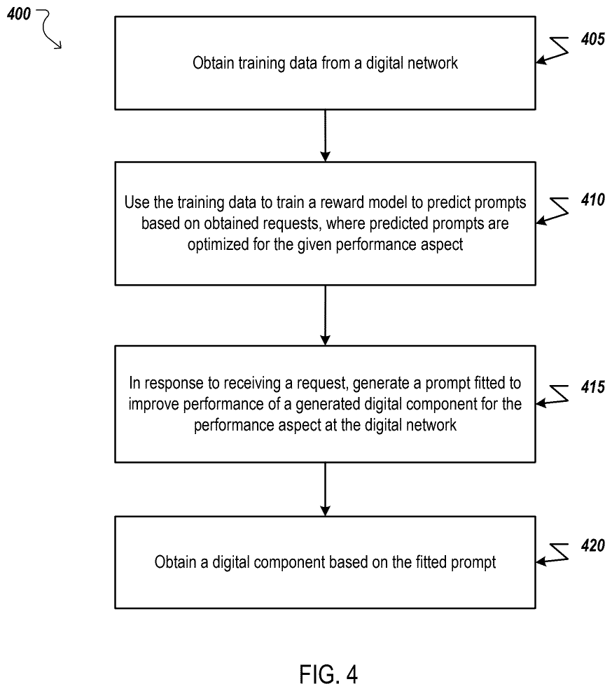

In some instances, the prompt can be provided to include the text input descriptive of the features of the digital component and the properties of the digital network to a directly trained model that focuses on optimizing the performance of digital components for the digital network. The trained model can be trained on input data from the digital network and in relation to historical behavior and performance of other digital components deployed at the network. In some instances, the training and the use of such a trained model can be performed as described in relation to training a reward model of FIG. 4.

The system obtained, from the one or more models, is a digital component of the one or more digital components that are generated based on the at least one prompt, by the one or more models (315).

The system distributes the digital component to the digital network for rendering through the digital network at one or more client devices (320).

In accordance with the execution of the process 300, the digital component generation is guided through the approximation of performance metrics for various performance aspects. In some instances, the performance of a digital component to be output from an AI model can be evaluated and approximated based on a trained model that is trained to predict the performance of a digital component, in accordance with a given performance aspect, e.g., engagement of the user, click interactions, etc.

FIG. 4 is a flow chart of an example of a process 400 for generating a digital component based on a prompt generated to improve performance of the digital component for one or more properties of the digital component and/or the digital environment in which the digital component will be presented. Operations of the process 400 can be performed, for example, by the service apparatus 110 of FIG. 1 (e.g., by the AI system 160), or another data processing apparatus. The operations of process 400 can be performed as described in relation to FIG. 2 and the interaction between the AI system 160 and the performance-aware prompt generation model 251. The operations of the process 400 can also be implemented as instructions stored on a computer readable medium, which can be non-transitory. Execution of the instructions, by one or more data processing apparatus, causes the one or more data processing apparatus to perform operations of the process 400. For brevity, the process 400 is described in terms of being performed by a system.

At 405, the system obtains training data from a digital network. The gathered data can include data from logs at the digital network that can be used to train a model to learn how digital components are used by the end-users. For example, the training data can be used to train a reward model to understand the digital component performance once deployed, for example, with regard to a given performance aspect such as end-user engagement or click responses. The training data can include data associated with the performance as measured according to the given performance scale, where such performance data is mapped to data associated with the respective digital component.

In some instances, the training data can include data for characteristics of the way that the digital component is provided (e.g., size, keywords associated with the displayed digital component, other metadata) and type of features included in the digital component such as text content or media content. The training data can also include collected data for user interactions, for example, tracking users associated with the digital network and providing instructions through network devices for interacting with the digital content. The data associated with the digital component as part of the training data can include:
i) metadata for features of digital components displayed through the digital network (e.g., placement of the digital component on a user interface when rendered at a client device, number of digital components displayed through the digital network to a given type of device, such as television, within a single user interface view or within a time period, other),
ii) properties of the digital components associated with a type of the digital network and the digital components (e.g., type of the content included in the digital component (e.g., text, images, video, etc.), size or length of the displayed contents, data about a requestor or owner of the digital components, keywords associated with the digital components, other), and
iii) log data for user interaction with digital components displayed through the digital network at client devices (e.g., logged traces including different type of events associated with user interaction such as views, a portion of the digital component that is viewed more often (e.g., based on eye tracking techniques), clicks on content part of the digital component when displayed,.

The system can use the training data to train the reward model to learn to estimate the performances of digital components according to the given performance aspect. In some instances, the reward model can be used at inference time during generation of a digital component to determine performance rates for multiple generated digital components as a candidate set that can be filtered to select one or more of the digital components that are associated with determined performance rates that meet a performance criterion. For example, the selected one or more digital components can have estimated performances meeting the performance criterion defined for a given performance aspect (e.g., conversion, engagement, brand building, etc.). Different techniques can be used for computing performance metrics according to different performance aspects. In some implementations, the reward model can be trained to predict prompts to improve performance in consideration of one or multiple performance aspects. In some instances, the reward model can receive as part of the prompt requesting to generate predicted prompts an indication of a relevant performance aspect for which to optimize the prompt. The reward model can be trained on training data associated with the digital network to be used for rendering the to be generated digital component or can be trained based on generic training data associated with multiple digital networks, for example, of the type of the digital network to be used for rendering the digital component.

The system generates, at 415, a prompt fitted to improve the performance of the generated digital component for the respective performance aspect (as related to the specific reward model or as requested). The generation is in response to a received request for generating a digital component, for example, such as the request received at 305 of FIG. 3.

The system obtains, at 420, from an AI model (e.g., the AI model 170 of FIG. 1 or 2), are a digital component generated based on the fitted prompt. The prompt generated at 415 can be used to query the AI model to obtain the digital component that can be used for rendering through the digital network at one or more client devices.

In some instances, a signal from a performance evaluation model can be obtained. The signal can include input information for performance of digital components when deployed at the digital network. The signal can include data related to content of the digital components ad rendered, user input for relevance of the digital component for one or more performance aspects (e.g., effectiveness of the digital component to improve brand awareness, to be easy to remember by target users, etc.). In some instances, obtained digital component, as at 420, can be evaluated by evaluating the obtained signal based on a defined performance metric for a selected performance aspect (e.g., brand awareness, conversion rate for content interaction, etc.). In response to determining that the digital component is not optimized to improve the selected performance aspect, a request can be sent, by the artificial intelligence system and to the one or more models, to generate a refined digital component. The generation of the refined digital component can be performed by guiding modifications for the digital component based on performance of the digital component for the selected performance aspect. In some instances, from the obtained signal for the performance, a portion of the data related to the selected performance aspect can be used and evaluated to be leveraged into the generation of the refined digital component so as to improve its performance according to the selected performance aspect. The refined digital component can be obtained based on executing the request at the one or more models.

FIG. 5 is a block diagram of an example of a block diagram 500 of an architecture of a system 500 for providing a digital component.

The system 500 includes an AI digital component generation model 525 that is configured to receive prompts based on requests for generating digital components and provide a digital component that is within an expected performance level in view of a given performance aspect at a digital network. In some instances, the AI digital component generation model 525 can receive an initial prompt 510, that can be substantially similar to the generated prompt at 310 of FIG. 3. The initial prompt 510 can include text assets descriptive of a digital component 515 and visual assets (e.g., images or videos) 520. The initial prompt 510 can be provided to the AI digital component generation model 525 to provide a digital component, such as the selected digital component 545 that is optimizing the performance for the one or more properties of the digital network according to a performance aspect.

In some implementations, the AI digital component generation model 525 includes the AI model 170 as described in relation to FIGS. 1 and 2, to query the AI model 170 based on the initial prompt 510 and obtain a set of candidate digital components 535. The generation of digital components by the AI model based on the initial prompt 515 can be performed as described in relation to FIGS. 1 and 2.

In some implementations, the set of candidate digital components 535 can be evaluated according to filtering logic 540 to determine a selected digital component 545 that is a component selected from the set 535 that is with a performance metric that complies with a performance criterion for selection. For example, a trained performance evaluation model can be implemented as part of the filtering logic 540 to determine expected performance metrics for each of the candidate digital components. As another example, the filtering logic 540 can include a selection logic that evaluates the candidate digital components based on a performance criterion defined for the digital network and determines the selected digital component 545. The filtering logic 540 can include selection logic that is based on performance measurement ranking, where the performance measurement can be performed by a performance evaluation model, such as the performance evaluation model 252 of FIG. 2.

In some implementations, the initial prompt 510 can be provided to a reward model 532 instead of being used for querying the AI digital component generation model 525. When the initial prompt 510 is provided to the reward model 532, the reward model 532 can refine the initial prompt to adjust it to the specifics of the digital network so that the generation process of a digital component is guided to provide a digital component that is with a higher estimated performance for a given performance aspect. The reward model 532 can be such as the reward model that is trained as described in relation to FIG. 4. The reward model 532 can be trained to use the data of the initial prompt 510 and to predict a new prompt that is fitted to improved performance with respect to a given performance aspect defined for the digital network. The reward model 532 can provide one or more predicted prompts that can be used to generate digital components associated with estimated performances meeting performance criteria defined for the given performance aspect. For example, a prompt can be provided that is expected to generate a digital component that can yield a certain level of customer engagement that can be measured according to a defined performance measurement (or formula).

For example, the initial prompt 510 can include a text input descriptive of a product such as “shoes”, and can include properties of the digital network such as defining that the device used for rendering the digital component is a television, that the target user profile is athletic students at the age of 22, and can identify that the digital component is associated with a particular brand, e.g., Brand X. In some instances, the initial prompt 510 can include visuals of the shoe product. Based on the received request including such example information, a new prompt can be generated that can be optimized for a particular performance aspect. The performance aspect for optimizing the prompt can be provided as part of the initial prompt 510, can be defined in the reward model, or can be obtained as external input. For example, the new prompt can be requested to be optimized for customer engagement performance. The new prompt can be defined for example as: “generate a video with asphalt focusing on the shoes in a photo-realistic setting, use cloudy skies, and have the logo clearly visible on the shoes.”

As another example, the initial prompt 510 can include a text input descriptive of a product such as “TV”, and can include properties of the digital network such as defining that the device used for rendering the digital component is a mobile phone, that the target user profile is old technical customers at the age of 66, and can identify that the digital component is associated with a particular brand, e.g., Brand X. In some instances, the initial prompt 510 can include visuals of the TV product. Based on the received request including such example information, a new prompt can be generated that is optimized to generate digital components that have improved conversion scores (e.g., according to a defined metric for measuring conversion). For example, the new prompt can be defined as: “generate a creative using a TV in a forest, emphasize a great discount price from standard, use cartoony output, illustrate smart TV features.”

In some instances, when a digital component, such as the selected digital component 545 is deployed at a digital network, feedback for the performance of the digital component 545 can be obtained and used to determine whether the performance matches the estimated performance for the digital component 545. In some instances, if the obtained feedback for the performance does not match a performance criterion, the digital component 545 can be used together with other descriptive data for the properties of the digital network and the features of the digital component to request refinement of the digital component 545. In some instances, the obtained feedback for the performance of multiple digital components at the digital network can be used to retrain the reward model 523, so that when a digital component is requested to be refined, a new prompt for generating the component can be used. In such a way, the digital component generation and refinement can be tailored to the current specifics of the digital network and can be flexible to adjust to modifications and learn new patterns of performance of digital components as a particular digital network.

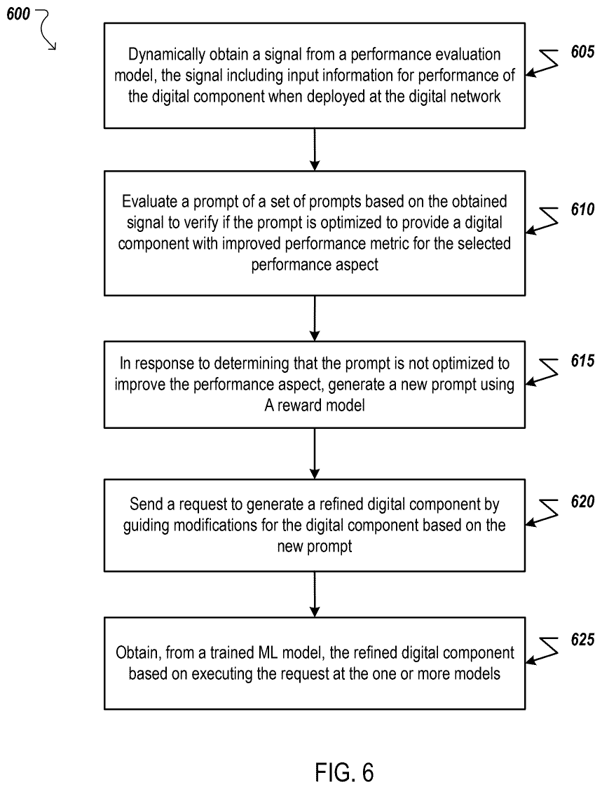

FIG. 6 is a block diagram of an example of a process 600 for generating a refined digital component based on a prompt optimized to improve the performance of a generated digital component at a digital network. Operations of the process 400 can be performed, for example, by the service apparatus 110 of FIG. 1 (e.g., by the AI system 160), or another data processing apparatus. The operations of process 600 can be performed as described in relation to FIG. 2 and the interaction between the AI system 160 and one or more models, e.g., one or more AI models which can include one or more language models. The operations of the process 600 can also be implemented as instructions stored on a computer readable medium, which can be non-transitory. Execution of the instructions, by one or more data processing apparatus, causes the one or more data processing apparatus to perform operations of the process 600. For brevity, the process 600 is described in terms of being performed by a system.

The system dynamically obtains (605) a signal from a performance evaluation model, such as the performance evaluation model 251 of FIG. 2. In some instances, the signal includes input information for performance of the digital component when deployed at the digital network.

The system evaluates (610) a prompt of a set of prompts based on the obtained signal to verify if the prompt is optimized to provide a digital component with improved performance metrics for the selected performance aspect. In some instances, the set of prompts can be prompts generated at operation 310 of FIG. 3. In some instances, the evaluated prompt can be a prompt generated by the prompt apparatus 230 of FIG. 2 or a prompt generated by a performance-aware prompt generation model 251. In some instances, the prompt that is evaluated can be a prompt that is optimized for a given performance aspect of the digital network, and the prompt can be evaluated for their performance with respect to another performance aspect, that being the selected performance aspect.

The system can generate (615), in response to determining that the prompt is not optimized to improve the performance aspect, a new prompt using a reward model, for example, the reward model can be substantially similar to the reward model 532 of FIG. 5.

The system can send (620) a request to one or more models to generate a refined digital component by guiding modifications for the digital component based on the new prompt.

The system can obtain (625) the refined digital component based on executing the request at the one or more models.

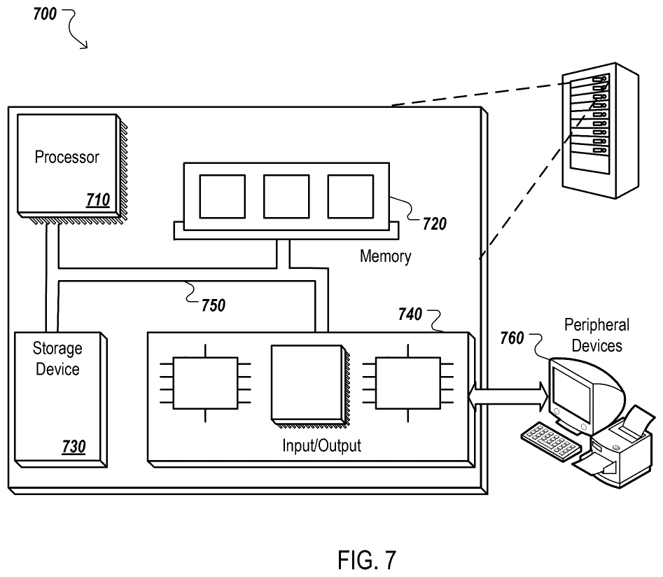

FIG. 7 is a block diagram of an example computer system 700 that can be used to perform the operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory720 is a computer-readable medium. In one implementation, the memory720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., an RS-232 port, and/or a wireless interface device, e.g., and an 802.11 card. In another implementation, the input/output device can include driver devices configured to receive input data and send output data to other devices, e.g., keyboard, printer, display, and other peripheral devices 750. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, a data processing apparatus. Alternatively, or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatuses, devices, and machines for processing data, including by way of example a programmable processor, a computer, a system on a chip, or multiple ones, or combinations, of the aforementioned. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

This document refers to a service apparatus. As used herein, a service apparatus is one or more data processing apparatuses that perform operations to facilitate the distribution of content over a network. The service apparatus is depicted as a single block in block diagrams. However, while the service apparatus could be a single device or a single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory, or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of the client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions, or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by an artificial intelligence system, a request including text input descriptive of features of a digital component and one or more properties of a digital network associated with displaying the digital component;
generating, by the artificial intelligence system, one or more prompts for use by one or more models to generate one or more digital components, wherein the one or more prompts are generated based on the text input and the one or more properties of the digital network;
obtaining, by the artificial intelligence system and from the one or more models, a digital component generated by the one or more models based on at least one of the one or more prompts; and
distributing the digital component to the digital network for rendering at one or more client devices.

2. The method of claim 1, wherein a prompt of the one or more prompts is generated, using a language model aligned with a performance criterion for digital components to be distributed to the digital network, to improve performance of the digital component based on the one or more properties of the digital network.

3. The method of claim 1, wherein the one or more models are trained to generate a prompt of the one or more prompts, the prompt being fitted to improve performance of a generated digital component for a given first performance aspect selected for the digital network as indicative of relevance of the digital component to target users of the digital network.

4. The method of claim 1, wherein obtaining the digital component comprises:
generating a plurality of digital components by the one or more models, each digital component being generated based on a different prompt of the one or more prompts;
predicting, using a reward model trained on performance data collected for the digital network, performance metrics for performance aspects of each of the plurality of digital components, wherein the performance metrics are predicted using a trained reward model; and
selecting the digital component from the plurality of digital components based on the performance metrics so that the digital component of the plurality of digital components has a performance metric meeting a selection criterion.

5. The method of claim 4, further comprising training the reward model, the training comprising:
obtaining training data from the digital network, wherein the training data comprises:
i) metadata for features of digital components displayed through the digital network,
ii) properties of the digital component associated with a type of the digital network and the digital components, and
iii) log data for user interaction with digital components displayed through the digital network at client devices; and
using the training data to train the reward model to learn to estimate performances of digital components according to the given performance aspect.

6. The method of claim 5, comprising:
using the training data to train the reward model to predict prompts fitted to improve performance with respect to a given performance aspect defined for the digital network, the predicted prompts being generated based on obtained requests, wherein the predicted prompts are for generating digital components having estimated performances meeting performance criteria defined for the given performance aspect.

7. The method of claim 4, wherein obtaining the digital component comprises:
dynamically obtaining a signal from a performance evaluation model, the signal including input information for performance of digital components when deployed at the digital network;
evaluating a prompt of the at least one prompt based on the obtained signal to verify if the prompt is optimized to provide a digital component with improved performance metric for the selected performance aspect;
in response to determining that the prompt is not optimized to improve the performance aspect, generating a new prompt using the reward model;
sending a request, by the artificial intelligence system and to the one or more models, to generate a refined digital component by guiding modifications for the digital component based on the new prompt; and
obtaining, from the trained model, the refined digital component based on executing the request at the one or more models.

8. The method of claim 1, wherein obtaining the digital component comprises:
dynamically obtaining a signal from a performance evaluation model, the signal including input information for performance of digital components when deployed at the digital network;
evaluating the digital component by evaluating the obtained signal based on defined performance metric for a selected performance aspect;
in response to determining that the digital component is not optimized to improve the selected performance aspect, sending a request, by the artificial intelligence system and to the one or more models, to generate a refined digital component by guiding modifications for the digital component based on performance of the digital component for the selected performance aspect; and
obtaining, from the trained model, the refined digital component based on executing the request at the one or more models.

9. The method of claim 1, wherein the one or more properties comprise at least one of a type of the digital network, a type of device that rendered digital components from the digital network, or a target user profile for the digital network.

10. A system comprising:
an artificial intelligence system comprising one or more processors; and
one or more storage devices storing instructions that, when executed by the one or more processors, cause the one or more processors to carry out operations comprising:
receiving, by the artificial intelligence system, a request including text input descriptive of features of a digital component and one or more properties of a digital network associated with displaying the digital component;
generating, by the artificial intelligence system, one or more prompts for use by one or more models to generate one or more digital components, wherein the one or more prompts are generated based on the text input and the one or more properties of the digital network;
obtaining, by the artificial intelligence system and from the one or more models, a digital component generated by the one or more models based on at least one of the one or more prompts; and
distributing the digital component to the digital network for rendering at one or more client devices.

11. The system of claim 10, wherein a prompt of the one or more prompts is generated, using a language model aligned with a performance criterion for digital components to be distributed to the digital network, to improve performance of the digital component based on the one or more properties of the digital network.

12. The system of claim 10, wherein the one or more models trained to generate a prompt of the one or more prompts, the prompt being fitted to improve performance of a generated digital component for a given first performance aspect selected for the digital network as indicative of relevance of the digital component to target users of the digital network.

13. The system of claim 10, wherein obtaining the digital component comprises:
generating a plurality of digital components by the one or more models, each digital component being generated based on a different prompt of the one or more prompts;
predicting, using a reward model trained on performance data collected for the digital network, performance metrics for performance aspects of each of the plurality of digital components, wherein the performance metrics are predicted using a trained reward model; and
selecting the digital component from the plurality of digital components based on the performance metrics so that the digital component of the plurality of digital components has a performance metric meeting a selection criterion.

14. The system of claim 13, wherein the operations comprise training the reward model, the training comprising:
obtaining training data from the digital network, wherein the training data comprises:
i) metadata for features of digital components displayed through the digital network,
ii) properties of the digital component associated with a type of the digital network and the digital components, and
iii) log data for user interaction with digital components displayed through the digital network at client devices; and
using the training data to train the reward model to learn to estimate performances of digital components according to the given performance aspect.

15. The system of claim 14, wherein the operations comprise:
using the training data to train the reward model to predict prompts fitted to improve performance with respect to a given performance aspect defined for the digital network, the predicted prompts being generated based on obtained requests, wherein the predicted prompts are for generating digital components having estimated performances meeting performance criteria defined for the given performance aspect.

16. The system of claim 13, wherein obtaining the digital component comprises:
dynamically obtaining a signal from a performance evaluation model, the signal including input information for performance of digital components when deployed at the digital network;
evaluating a prompt of the at least one prompt based on the obtained signal to verify if the prompt is optimized to provide a digital component with improved performance metric for the selected performance aspect;
in response to determining that the prompt is not optimized to improve the performance aspect, generating a new prompt using the reward model;
sending a request, by the artificial intelligence system and to the one or more models, to generate a refined digital component by guiding modifications for the digital component based on the new prompt; and
obtaining, from the trained model, the refined digital component based on executing the request at the one or more models.

17. The system of claim 10, wherein obtaining the digital component comprises:
dynamically obtaining a signal from a performance evaluation model, the signal including input information for performance of digital components when deployed at the digital network;
evaluating the digital component by evaluating the obtained signal based on defined performance metric for a selected performance aspect;
in response to determining that the digital component is not optimized to improve the selected performance aspect, sending a request, by the artificial intelligence system and to the one or more models, to generate a refined digital component by guiding modifications for the digital component based on performance of the digital component for the selected performance aspect; and
obtaining, from the trained model, the refined digital component based on executing the request at the one or more models.

18. The system of claim 10, wherein the one or more properties comprise at least one of a type of the digital network, a type of device that rendered digital components from the digital network, or a target user profile for the digital network.

19. A non-transitory computer readable storage medium carrying instructions that, when executed by one or more processors of an artificial intelligence system, cause the one or more processors to carry out operations comprising:
receiving, by an artificial intelligence system, a request including text input descriptive of features of a digital component and one or more properties of a digital network associated with displaying the digital component;
generating, by the artificial intelligence system, one or more prompts for use by one or more models to generate one or more digital components, wherein the one or more prompts are generated based on the text input and the one or more properties of the digital network;
obtaining, by the artificial intelligence system and from the one or more models, a digital component generated by the one or more models based on at least one of the one or more prompts; and
distributing the digital component to the digital network for rendering at one or more client devices.

20. The non-transitory computer readable storage medium of claim 19, wherein a prompt of the one or more prompts is generated, using a language model aligned with a performance criterion for digital components to be distributed to the digital network, to improve performance of the digital component based on the one or more properties of the digital network.
